(19) United States
(12) Patent Application Publication
(10) Pub. No.: US 2019/0168657 A1
(43) Pub. Date: Jun. 6, 2019

(54) TRUCK BED CARGO LIFT AND LOADER

(71) Applicant: 1908554 Alberta Ltd., St. Albert (CA)

(72) Inventors: Raymond LAI, St. Albert (CA); David DEJONG, Edmonton (CA); Darryl SHORT, Edmonton (CA); Miguel A.F. RODRIGUES, Sherwood Park (CA)

(21) Appl. No.: 16/210,249

(22) Filed: Dec. 5, 2018

(30) Foreign Application Priority Data
Dec. 6, 2017 (CA) 2 988 031

(51) Int. Cl. B60P 1/44; B60P 1/12

(52) U.S. Cl. CPC B60P 1/4492; B60P 1/12

(57) ABSTRACT

A truck bed cargo lift and loader is provided consisting of a pivotable and extendable platform or tray whose side supports are connected to linkage bars attached to carriers located in proximity to each base beam on the side of the lift and loader towards the open end of the truck bed, and which carriers travel along a worm gear jack screw with opposing threads installed in the cross member connecting the side base beams, such that when the jack screw rotates upon being driven by an electric motor or by a manually operated hand crank connected to a gearbox attached to the jack screw, the carriers travel towards and away from each other depending on the direction of rotation of the jack screw thereby raising and lowering the linkage bars with their platform or tray.

### TECHNICAL FIELD

The invention relates to devices for use in the cargo beds of pickup trucks, and more particularly, to devices to load, lift, carry and securely store cargo and accessories in truck beds.

### BACKGROUND

Existing truck bed cargo racks have deficiencies in that they are bulky, heavy, and are usually immovable. Once the rack is installed, the flexibility of the truck bed to carry items of diverse kinds, is reduced. Particularly, the space above the sides and middle of the truck bed goes to waste. Additionally, other forms of truck bed cargo lift are raised and lowered by means of jacks so placed as to block access to the truck bed itself.

### SUMMARY OF INVENTION

A truck bed cargo lift and loader is provided, compatible with most existing truck beds, their tonneau covers, and many types of cargo racks as well as being useable with 5th wheel trailer hitches. The lift and loader can be raised and lowered, with its cargo carrying platform or tray being rolled in and out of the truck bed, for ease of loading. The lift and loader can be used to anchor and lock cargo such as bicycles, skis, kayaks or accessories to its platform or tray. The lift and loader is raised and lowered through a gearbox connected to a manually operated hand crank or connected to an electric hand drill located on a side of the bottom base support of the device, which through a gearbox rotates a worm gear jackscrew with opposing threads, upon which carriers connected to linkage bars located on each side of the lift and loader travel towards and away from each other and thereby raise and lower the cargo-carrying platform.

### BRIEF DESCRIPTION OF THE DRAWINGS

FIG. 1 shows a perspective frontal view of an embodiment of the truck bed cargo lift and loader in an open position, with its raised and extended platform or tray situate towards the rear, or open end of the truck bed itself.

FIG. 2 is a perspective rear view of the lift and loader from the rear or open end of the truck bed, with its raised and extended platform or tray so situate.

FIG. 3 is a side view of the lift and loader shown in FIGS. 1 and 2 with an electric hand drill with torque strut shown to scale relative to the other components.

FIG. 4 is a top view of the lift and loader shown in FIGS. 1, 2 and 3.

FIG. 5 is view of the underside of the lift and loader shown in FIGS. 1, 2, 3 and 4, with the platform or tray in an extended position and with the placement of an electric hand drill on the gearbox located at the rearmost cross member.

FIG. 6 is a rear plan view of the lift and loader shown in FIGS. 1, 2, 3, 4 and 5 showing the platform or tray in an extended position.

FIG. 7 is a detail view of the platform or tray support beam extrusion located on each side of the lift and loader depicting its lock slots, fastener channels and C-channel wheel sliding rail.

FIG. 8 shows an electric hand drill located as shown in FIG. 5 attached to the reactive torque attachment strut.

FIG. 9 shows an embodiment of the base beam cross member extrusion in which the worm gear jackscrew is situate with the carriers for the linkage bars attached to the platform or tray are shown on each side, and which shows the placement of the gearbox for driving the rotation of the worm gear jackscrew.

FIG. 10 is a detail view of an embodiment of the carrier which travels along the worm gear jack screw, with the carrier's locking pin and shaft extending through the rod-end attached to the linkage bar which is connected to the platform or tray.

FIG. 11 is a view of the underside of the platform or tray and its side support beams containing wheels which travel within the C-channel shown in FIG. 7.

FIG. 12 is a view of the cross section of the accessory cross bar of the lift and loader depicting the channels in which the T-slot accessory attachment members travel within the cross bar.

FIG. 13 is a view of the T-slot accessory attachment member with its circular hole in the bar of the T-slot accessory attachment member.

FIG. 14 is a view of an embodiment of the loop or eyebolt through which ratchet hooks or bolts can be placed to secure the base of the lift and loader, to the truck bed.

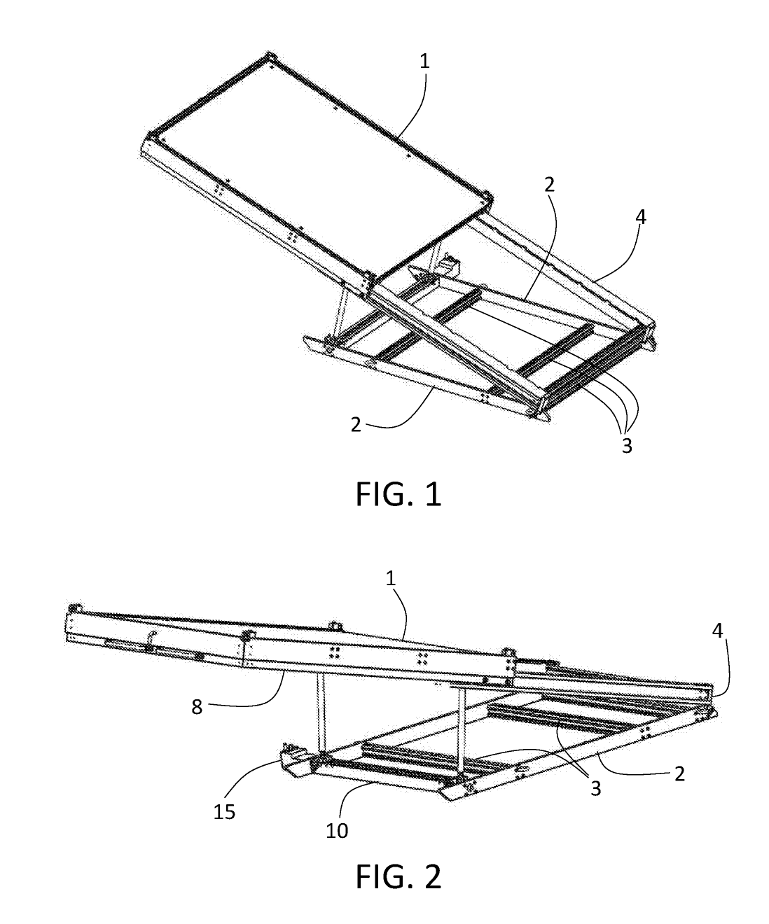

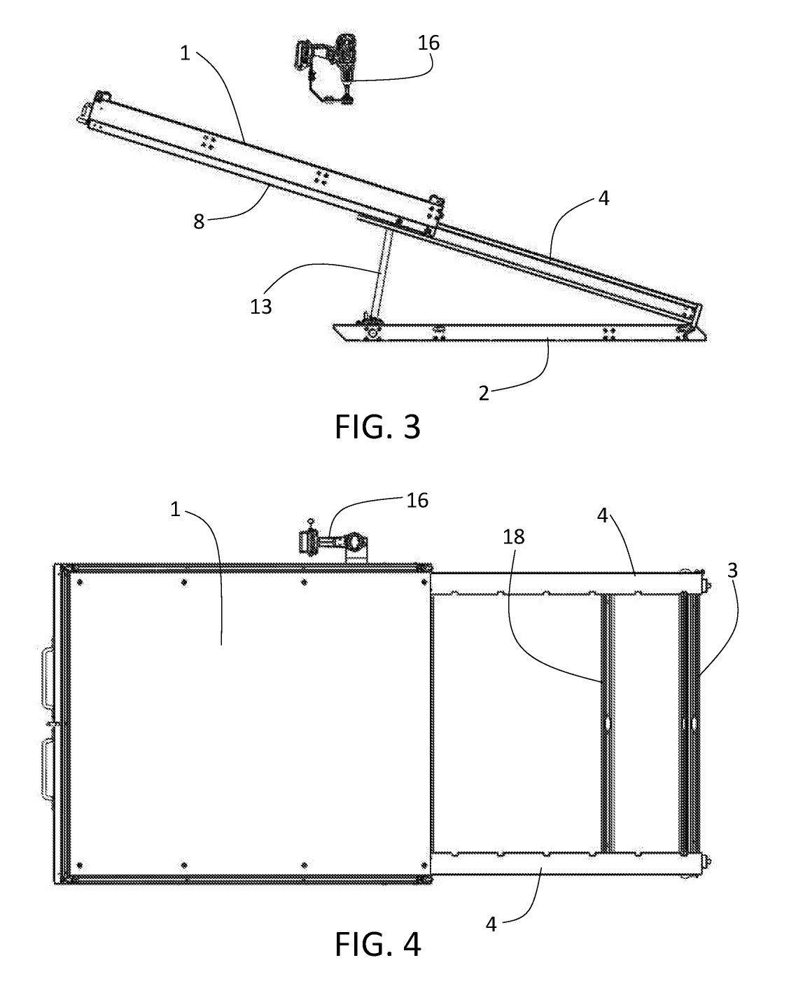

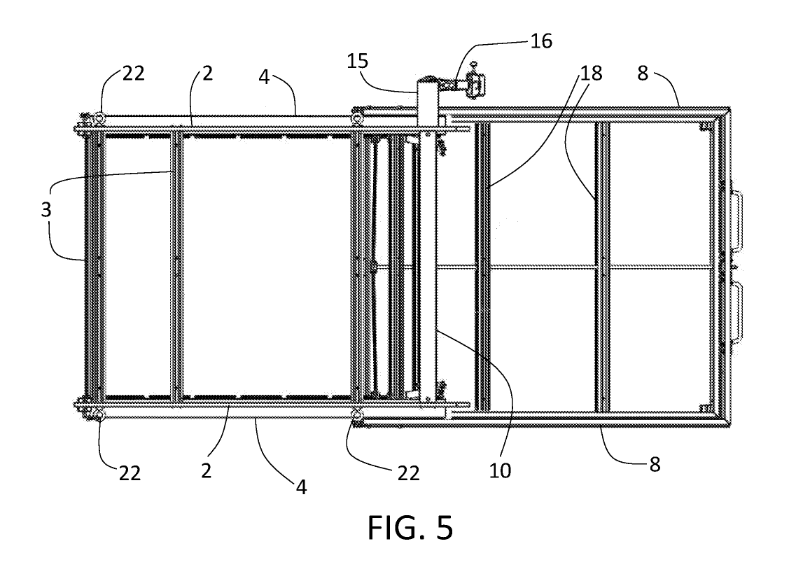

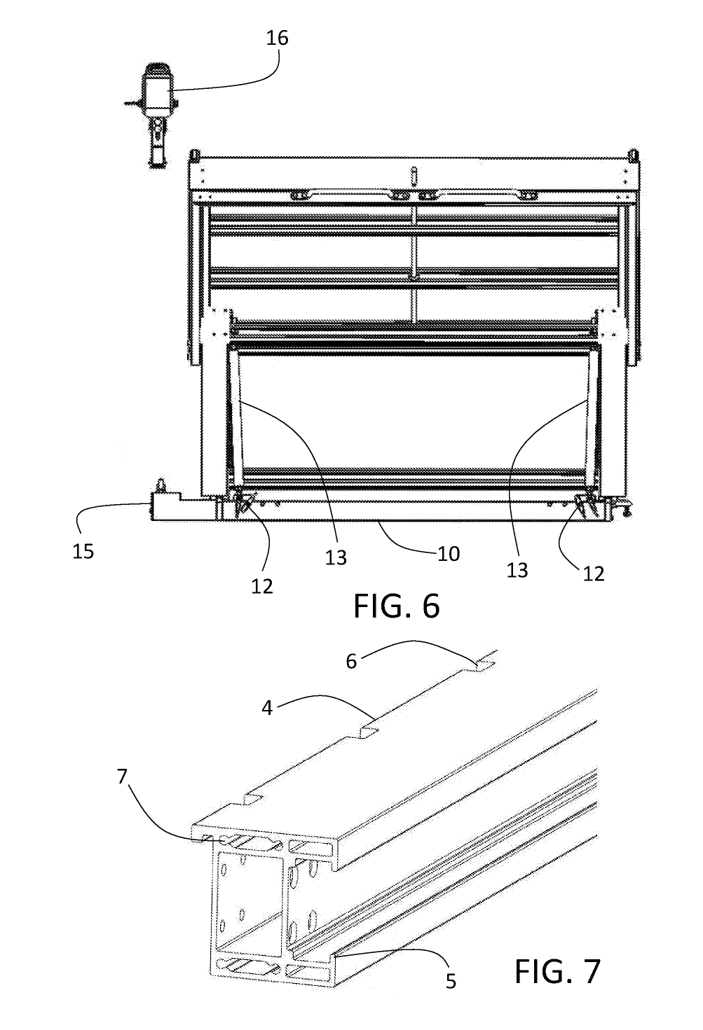

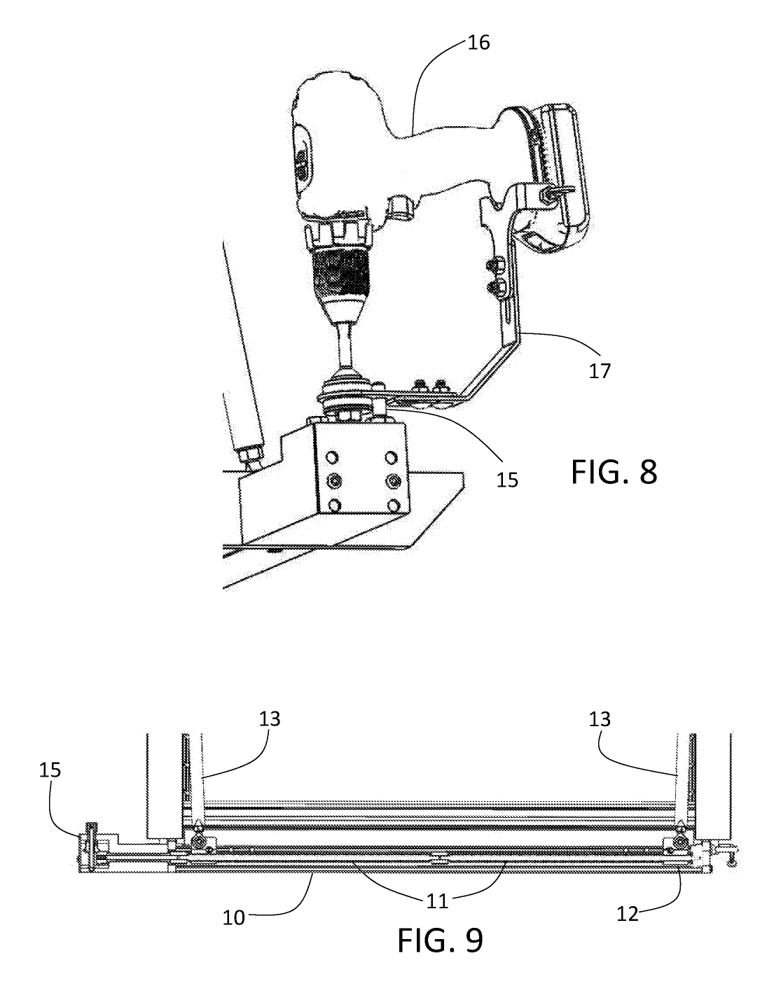

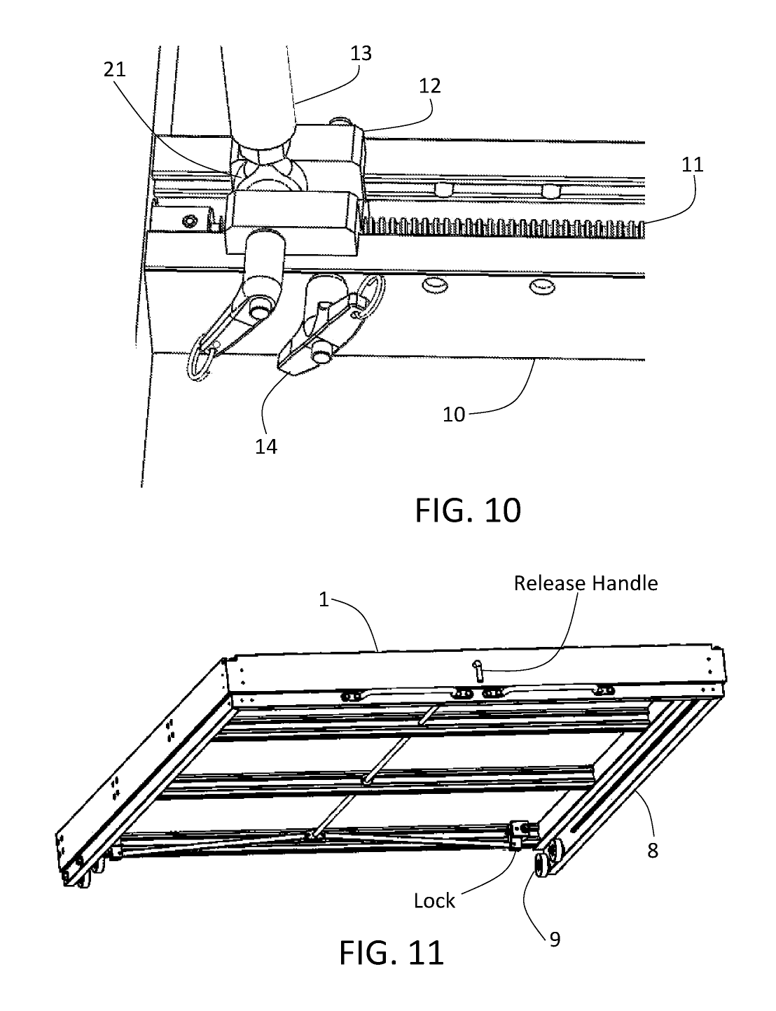

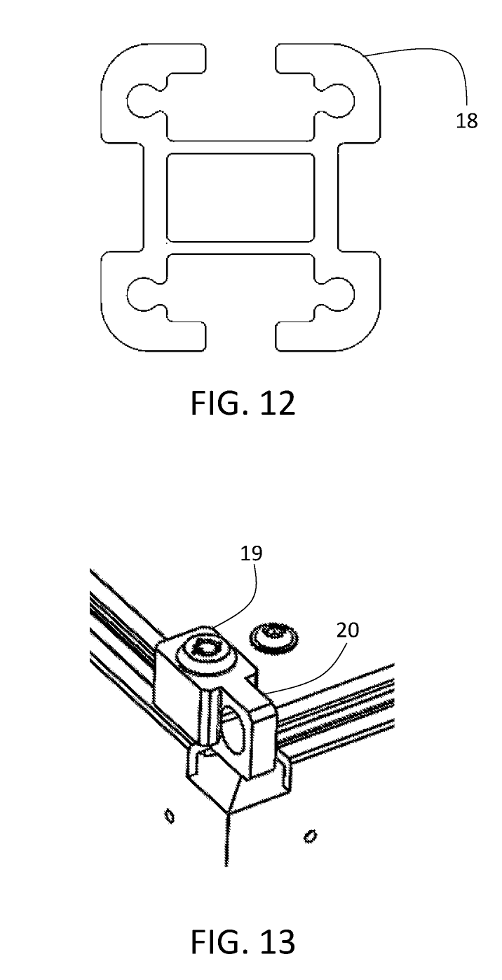

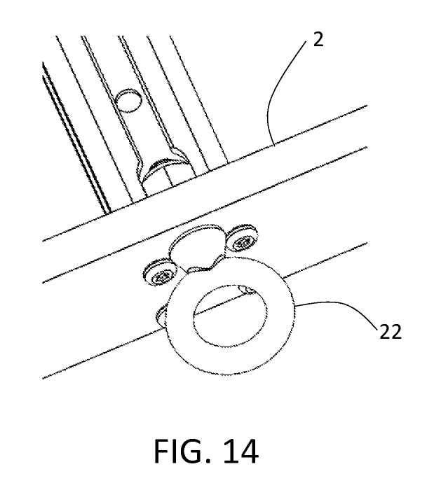

### DETAILED DESCRIPTION OF THE INVENTION

A truck cargo lift and loader is provided including a base beam 2 placeable within the cargo bed of a truck; a platform or tray 1 with its first end pivotably connectable to the base beam 2 proximate to a first end of the base beam 2; and base beam cross members 3.

A platform or tray support beam 4 on each side of the platform or tray pivotably secured to the platform and pivotably secured to the base beam proximate to a second end of the base beam, and in which the support is moveable from a first position wherein a second end of the platform is positioned to the base beam to a second position wherein the second end of the platform is elevated relative to the base beam; and

The individual base beam 1 platform and side supports 2 are composed of metallic extrusions; and in which the support beam 4 extrusion on each side of the platform consists of a wheel sliding rail 5 linear lock slots 6 and fastener channels; and

The lifting mechanism consists of a base beam cross member 10 extrusion running from each side of the first end of the base beam to its counterpart on the other side, containing within it a rotatable bar 11 in the form of a worm gear jackscrew with opposing threads extending to bearings installed in the first ends of the base beam cross members on each side of the lift, and upon which travels a locking-pinnable carrier 12 on each side of the base beam extrusion that is connected to a linkage bar 13 attached to the carrier by the shaft of the locking pin 14 extending through a rod-end bearing 21 on the bottom of the linkage bar 13 so that when the threaded bar 11 rotates, the carriers 12 travel opposite to each other along it so that the linkage bars 13 on each side connected to the support beams 4 on each side, raise and lower the platform or tray 1.

The rotation of the threaded bar 11 is by its being connected to a gearbox 15 located on 1 side of the base beam cross member extrusion, with the gearbox being driven either by a manually operated hand crank (not shown) or is driven by means of being connected by a shaft into the mandrel of a hand drill 16 securely affixed to the gearbox by means of a reactive torque attachment strut 17 so that when the drill is energized the drill body does not move and the torque of the drill is transmitted through the gearbox to the worm gear jackscrew 11 causing it to rotate and thereby move the travelling carriers 12 so as to lift the side support beams 4 and the platform or tray 1; and

The platform or tray 1 consists of metallic extrusions along its sides 8 equipped with wheels 9 which travel along wheel sliding rail situate within the C-channel side support beams 4 as these raise and lower.

The platform's metallic extrusions also consist of hollow cross-bars 18, the internal shape of which mates with sliding, lockable T-slot securing members 19 to which accessories can be attached.

The T-slot 19 contains a circular hole in the bar 20 under the T, to accommodate a cable lock to secure accessories to the T-slot and thence to the cross-bar.

The base bar 2 on each side of the assembly is bolted to the surface of the truck bed, or is attached with an eye-bolt or loop 22 which can be attached to an equivalent bolt on the truck bed using a suitable ratcheting tie-down.

The embodiments of the present application described above are intended to be examples only. Those of skill in the art may effect alterations, modifications and variations to the particular embodiments without departing from the intended scope of the present application. In particular, features from one or more of the above-described embodiments may be selected to create alternate embodiments comprised of a subcombination of features which may not be explicitly described above. In addition, features from one of more of the above-described embodiments may be selected and combined to create alternate embodiments comprised of a combination of features which may not be explicitly described above. Features suitable for such combinations and subcombinations would be readily apparent to persons skilled in the art upon review of the present application as a whole. Any dimensions provided in the drawings are for illustrative purposes only and are not intended to be limiting on the scope of the invention. The subject matter described herein and in the recited claims intends to cover and embrace all suitable changes in technology.

What is claimed is:

1. A loader and lift for the cargo bed of a truck comprising:
2 base beams placeable within and on each side of the cargo bed of a truck;
a platform with its first end pivotably connectable to each base beam proximate to the first end of each base beam;
a support pivotably secured to the platform and pivotably secured to each base beam proximate to a second end of the base beam, and wherein the support is moveable from a first position wherein a second end of the platform is positioned proximate to the base beam to a second position wherein the second end of the platform is elevated relative to the base beam.

2. The loader and lift of claim 1, further comprising:
a platform extension or tray configured to retractably extend from the second end of the platform, by means of wheels attached to the platform extension or tray.

3. The loader and lift of claim 1 further comprising a plurality of loops in the form of eye-bolts configured to secure the base beams to the truck bed by means of ratcheting tie-downs or by a plurality of holes in the base beams through which securing bolts can be passed into matching holes drilled in the truck bed.

4. The loader and lift of claim 2 wherein the individual base beams on each side of the truck bed and the platform and the platform's side support beams are composed of metallic extrusions, and in which the platform's support beam extrusion on each side of the platform consists of a wheel sliding rail in the form of a C-channel in which the wheeled platform extension or tray travels in and out, and in which the support beam extrusion on each side has linear lock slots and fastener channels.

5. The loader and lift of claim 1 wherein the lifting mechanism consists of a crosswise base beam extrusion running from each side of the base beam to its counterpart on the other side, containing within it a rotatable bar in the form of worm gear jackscrew with opposing threads extending to bearings installed in the first ends of the base beams on each side of the lift and loader and upon which travels a locking-pinnable carrier on each side of the base beam extrusion that is connected to a linkage bar attached to the carrier by the shaft of the locking pin extending through a rod-end bearing on the bottom of the linkage bar so that when the threaded bar rotates, the carriers travel opposite to each other along it so that the linkage bars on each side, connected to the support beams of the platform on each of its side, raise and lower the platform.

6. The loader and lift of claim 1 in which the rotation of the threaded bar inside the base beam extrusion is by its being connected to a gearbox located on 1 side of the base beam extrusion, with the gearbox being driven by a manually operated hand crank or is connected by a shaft into the mandrel of an electric hand drill securely affixed to the gearbox by a reactive torque attachment strut so that when the drill is energized the drill body does not move and the torque of the drill or of the manually operated hand crank is transmitted through the gearbox to the rotatable screw threaded bar, causing it to rotate and thereby move the travelling carriers so as to raise and lower the side support beams of the platform.

7. The loader and lift of claim 4 in which the platform extension or tray which carries the cargo consists of metallic extrusions on each side of its lower surface equipped with wheels which travel along and inside the C-channel platform side support beam so that the platform or tray can move in and out.

8. The loader and lift of claim 1 in which the platform or tray consists of metallic extrusions in the form of hollow cross bars running from each side of its wheeled lower surface bar, to its counterpart on the other side, and in which the hollow cross bars are so shaped internally so as to mate with lockable, moveable T-slot securing members to which cargo and accessories can be attached.

9. The loader and lift of claim 1 in which the platform or tray is equipped with a removable deck or covering.

10. The loader and lift of claim 1 in which the T-slot securing member contains a circular hole in the bar under its T, to accommodate a cable lock to secure cargo and accessories to the T-slot member and thence to the cross-bar.
